(19) United States
(12) Patent Application Publication
(10) Pub. No.: US 2024/0389149 A1
(43) Pub. Date: Nov. 21, 2024

(54) METHOD AND APPARATUS FOR LOW LATENCY COMMUNICATION IN WIRELESS LOCAL AREA NETWORK

(71) Applicants: Hyundai Motor Company, Seoul (KR); Kia Corporation, Seoul (KR); Korea National University of Transportation Industry-Academic Cooperation Foundation, Chungju (KR)

(72) Inventors: Yong Ho Kim, Incheon (KR); Ju Seong Moon, Osan (KR)

(21) Appl. No.: 18/783,642

(22) Filed: Jul. 25, 2024

Related U.S. Application Data
(63) Continuation of application No. PCT/KR2023/001257, filed on Jan. 27, 2023.

(30) Foreign Application Priority Data
Jan. 28, 2022 (KR) 10-2022-0013564

(51) Int. Cl. H04W 74/0816; H04W 28/02; H04W 84/12

(52) U.S. Cl. CPC H04W 74/0816; H04W 28/0278; H04W 84/12

(57) ABSTRACT

A method and apparatus for low latency communication in a wireless LAN support an enhanced multi-link single radio (eMLSR) operation. A method of operating a station (STA) includes steps of: identifying, by a processor of the station, a restricted target wake time (rTWT) service period (SP) configured by an access point (AP); and receiving, from the AP, a data frame without reception of an initial control frame of the AP within the rTWT SP. A period receivable on multiple spatial streams in a low latency communication service period may be clearly configured, and an eMLSR STA may transmit a frame in the corresponding period. Also, the eMLSR STA may receive the data frame without the reception of the initial control frame of the AP. Accordingly, low latency demands for frame transmission may be satisfied, and the frame may be transmitted at a high speed.

### CROSS-REFERENCE TO RELATED APPLICATIONS

The present application is a continuation of International Application No. PCT/KR2023/001257 filed on Jan. 27, 2023, which claims under 35 U.S.C. § 119 (a) the benefit of Korean Patent Application No. 10-2022-0013564 filed on Jan. 28, 2022, the entire contents of which are incorporated by reference herein.

### BACKGROUND

### (a) Technical Field

The present disclosure relates to a wireless local area network (LAN) communication technique, and more particularly, to a low-latency communication technique for a wireless LAN supporting enhanced multi-link single radio (eMLSR) operations.

### (b) Description of the Related Art

Recently, along with the spread of mobile devices, a wireless local area network technology capable of providing fast wireless communication services to mobile devices is also required. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

In wireless LANs, improvements to the Carrier Sensing Multiple Access/Collision Avoidance (CSMA/CA) scheme may be necessary for low-latency operations (e.g., low-latency communications). When using the CSMA/CA scheme, a communication node can perform a channel access operation to transmit data (e.g., data frames), and if a result of the channel access operation indicates an idle state, the communication node can transmit the data. In other words, the communication node needs to compete with other communication nodes to transmit data. Since time is consumed by this competition, the data may not be transmitted quickly, and low-latency requirements for data transmission may not be satisfied.

Meanwhile, the technologies that are the background of the present disclosure are written to improve the understanding of the background of the present disclosure and may include content that is not already known to those of ordinary skill in the art to which the present disclosure belongs.

### SUMMARY

The present disclosure is directed to a method and an apparatus for low-latency communication in a wireless LAN supporting enhanced multi-link single radio (eMLSR) operations.

A method of operating a station (STA), according to a first exemplary embodiment of the present disclosure for achieving the above-described objective, may comprise: identifying, by a processor of the station, a restricted target wake time (rTWT) service period (SP) configured by an access point (AP); and receiving, by the processor, a data frame from the AP within the rTWT SP without receiving an initial control frame of the AP.

The STA may operate in a receiving mode or a listening mode, the STA operating in the receiving mode may receive the data frame without receiving the initial control frame, and the STA operating in the listening mode may receive the data frame after receiving the initial control frame.

The method may further comprise: transitioning an operating mode of the STA from the listening mode to the receiving mode at a start time of the rTWT SP.

The method may further comprise: transitioning an operating mode of the STA from the receiving mode to the listening mode after an end time of the rTWT SP.

The method may further comprise: in response to the data frame including a listening mode transition indicator, transitioning an operating mode of the STA from the receiving mode to the listening mode after transmission of a response frame for the data frame.

The method may further comprise: receiving a beacon frame including rTWT SP information from the AP, wherein the rTWT SP information may include at least one of information on a start time of the rTWT SP or information on a duration of the rTWT SP, and the rTWT SP may be identified based on the rTWT SP information.

The initial control frame may be a multi-user (MU)-request-to-send (RTS) frame or a buffer status report poll (BSRP) trigger frame.

The STA may be affiliated with a STA multi-link device (MLD), the AP may be affiliated with an AP MLD, and the STA may support enhanced multi-link single radio (eMLSR) operations.

The STA may receive the data frame using multiple spatial streams.

A method of operating an access point (AP), according to a second exemplary embodiment of the present disclosure for achieving the above-described objective, may comprise: transmitting, by a processor of the station, restricted target wake time (rTWT) service period (SP) information; and transmitting, by the processor, a data frame to a station (STA) without transmitting an initial control frame within a rTWT SP configured by the rTWT SP information.

The STA may operate in a receiving mode or a listening mode, the STA operating in the receiving mode may receive the data frame without receiving the initial control frame, and the STA operating in the listening mode may receive the data frame after receiving the initial control frame.

The operating mode of the STA may transition from the listening mode to the receiving mode at a start time of the rTWT SP, and the operating mode of the STA may transition from the receiving mode to the listening mode after an end time of the rTWT SP.

When the data frame includes a listening mode transition indicator, the operating mode of the STA may transition from the receiving mode to the listening mode after transmission of a response frame for the data frame.

The rTWT SP information may include at least one of information on a start time of the rTWT SP or information on a duration of the rTWT SP, the initial control frame may be a multi-user (MU)-request-to-send (RTS) frame or a buffer status report poll (BSRP) trigger frame, and the data frame may be transmitted using multiple spatial streams.

The STA may be affiliated with a STA multi-link device (MLD), the AP may be affiliated with an AP MLD, and the STA may support enhanced multi-link single radio (eMLSR) operations.

A station (STA), according to a third exemplary embodiment of the present disclosure for achieving the above-described objective, may comprise: a processor, and the processor may cause the STA to perform: identifying a restricted target wake time (rTWT) service period (SP) configured by an access point (AP); and receiving a data frame from the AP within the rTWT SP without receiving an initial control frame of the AP.

The STA may operate in a receiving mode or a listening mode, the STA operating in the receiving mode may receive the data frame without receiving the initial control frame, and the STA operating in the listening mode may receive the data frame after receiving the initial control frame.

The processor may further cause the STA to perform: transitioning an operating mode of the STA from the listening mode to the receiving mode at a start time of the rTWT SP; and transitioning the operating mode of the STA from the receiving mode to the listening mode after an end time of the rTWT SP.

The processor may further cause the STA to perform: in response to the data frame including a listening mode transition indicator, transitioning an operating mode of the STA from the receiving mode to the listening mode after transmission of a response frame for the data frame.

The STA may be affiliated with a STA multi-link device (MLD), the AP may be affiliated with an AP MLD, the STA may be an enhanced multi-link single radio (eMLSR) STA supporting eMLSR operations, and the STA may receive the data frame using multiple spatial streams.

According to the present disclosure, a period during which reception through multiple spatial streams is possible can be clearly configured within a low-latency communication service period, allowing an eMLSR STA to transmit frames within this period. Furthermore, the eMLSR STA can receive data frames without needing to receive an initial control frame from an AP. Consequently, low-latency requirements for frame transmissions can be met, and data frames can be transmitted at high speed.

### BRIEF DESCRIPTION OF THE DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6 is a timing diagram illustrating a first exemplary embodiment of a method for transmitting and receiving a single user frame in a restricted target wake time (rTWT) service period (SP) of an eMLSR STA.

FIG. 7 is a timing diagram illustrating a second exemplary embodiment of a method for transmitting and receiving a single user frame in a rTWT SP of an eMLSR STA.

FIG. 8 is a timing diagram illustrating a third exemplary embodiment of a method for transmitting and receiving a single user frame in a rTWT SP of an eMLSR STA.

FIG. 9 is a timing diagram illustrating a fourth exemplary embodiment of a method for transmitting and receiving a single user frame in a rTWT SP of an eMLSR STA.

FIG. 10 is a timing diagram illustrating a first exemplary embodiment of a method for transmitting and receiving a multi-user frame in a rTWT SP of an eMLSR STA.

FIG. 11 is a timing diagram illustrating a second exemplary embodiment of a method for transmitting and receiving a multi-user frame in a rTWT SP of an eMLSR STA.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

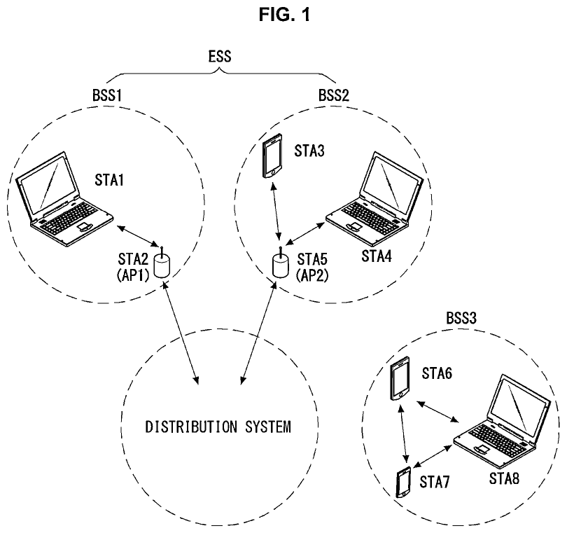

FIG. 1 is a conceptual diagram illustrating a first exemplary embodiment of a wireless LAN system.

As shown in FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

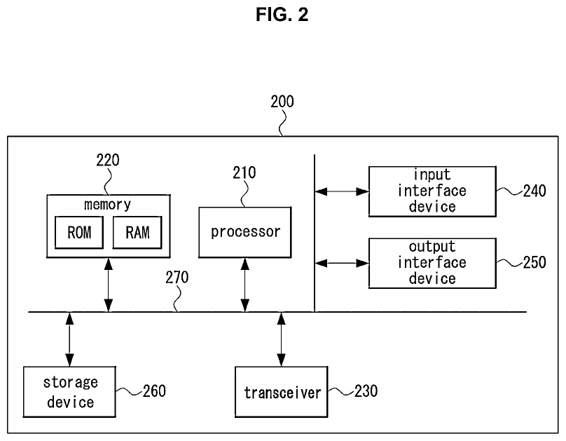

FIG. 2 is a block diagram illustrating a first exemplary embodiment of a communication node constituting a wireless LAN system. As shown in FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

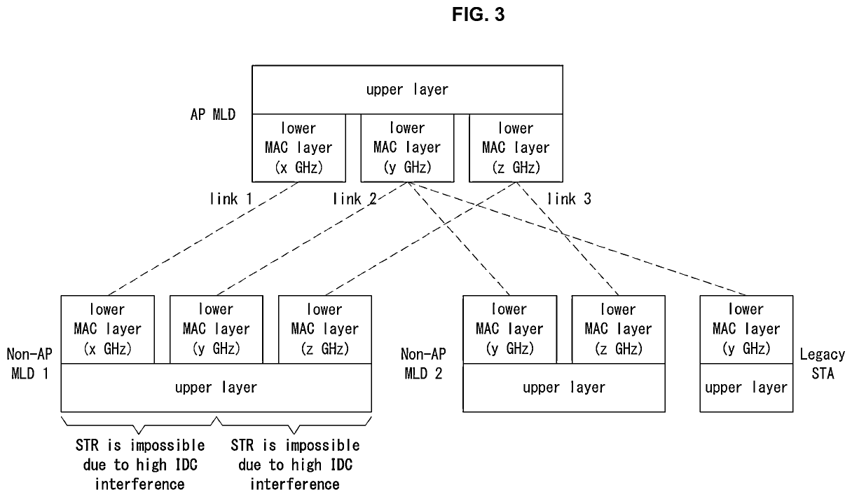

FIG. 3 is a conceptual diagram illustrating a first exemplary embodiment of a multi-link configured between multi-link devices (MLDs).

As shown in FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHZ). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2). The MLD may perform communications in multiple bands (i.e., multi-band). For example, the MLD may perform communications using a 40 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHZ bandwidth in the 5 GHz band, and may perform communications using a 160 MHZ bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The

MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as receiver address(es), and may generate and transmit frame(s) including the receiver address(es).

Meanwhile, an association procedure in a wireless LAN system may be performed as follows.

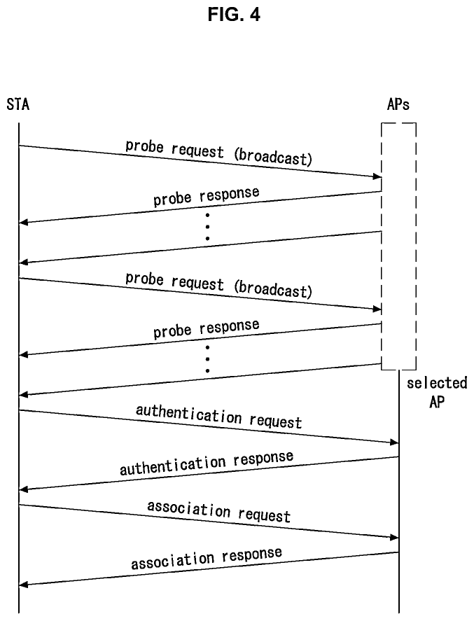

FIG. 4 is a sequence chart illustrating an association procedure of a station in a wireless LAN system.

As shown in FIG. 4, an association procedure of a STA in an infrastructure BSS may generally be divided into a probe step of detecting AP(s), an authentication step with detected AP(s), and an association step with the authenticated AP(s). The STA may be a

STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g., access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

An initial control frame may include an acknowledgment (ACK) frame, block ACK request (BAR) frame, block ACK (BA) frame, power saving (PS)-Poll frame, request-to-send (RTS) frame, clear-to-send (CTS) frame, and the like. Although specified as an initial control frame in the present disclosure, the initial control frame may be interpreted as a control frame (e.g., general control frame). For example, an initial control frame may also be interpreted as a non-initial control frame depending on a context. The data frame may be classified into a quality of service (QOS) data frame and a non-QoS data frame. The QoS data frame may refer to a data frame for which transmission according to a QoS is required, and the non-QoS data frame may indicate a data frame for which transmission according to a QoS is not required. The QoS data frame may include a QoS Null frame, and the QoS Null frame may not include a payload.

Meanwhile, in a wireless LAN system, a communication node (e.g., access point or station) may operate based on the EDCA scheme.

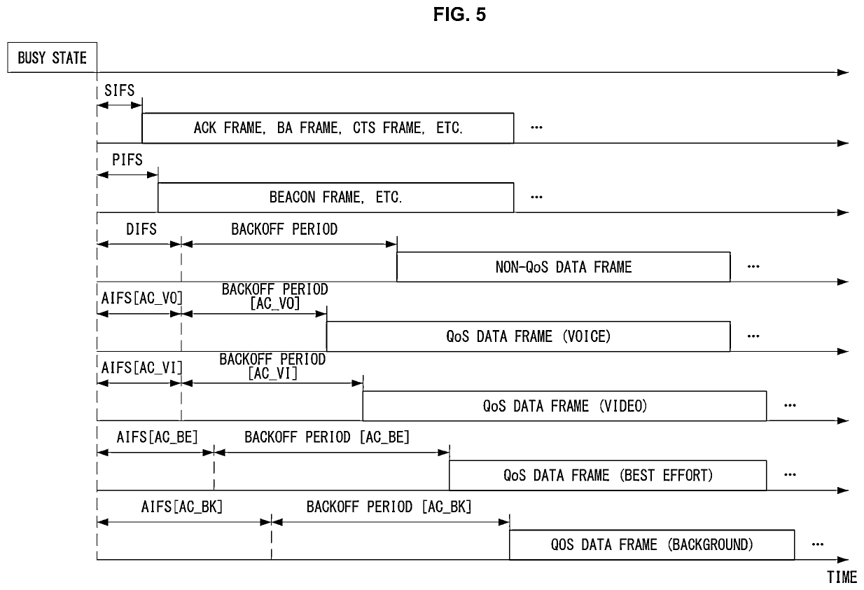

FIG. 5 is a timing diagram illustrating a first exemplary embodiment of an operation method of a communication node based on EDCA.

As shown in FIG. 5, a communication node desiring to transmit an initial control frame (or, management frame) may perform a channel state monitoring operation (e.g., carrier sensing operation) during a predetermined period (e.g., short interframe space (SIFS) or PCF IFS (PIFS)), and when the channel state is determined to be idle during the predetermined period (e.g., SIFS or PIFS), the communication node may transmit the initial control frame (or, management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g., SIFS or PIFS), the communication node may not transmit the initial control frame (or, management frame). Here, the carrier sensing operation may refer to a clear channel assessment (CCA) operation.

A communication node desiring to transmit a non-QoS data frame may perform a channel state monitoring operation (e.g., carrier sensing operation) during DCF IFS (DIFS), and when the channel state is determined to be idle during the DIFS, the communication node may perform a random backoff procedure. For example, the communication node may select a backoff value (e.g., a backoff counter) within a contention window according to the random backoff procedure and may perform a channel state monitoring operation (e.g., carrier sensing operation) during a period corresponding to the selected backoff value (hereinafter, referred to as ‘backoff period’). The communication node may transmit the non-QoS data frame when the channel state is determined to be idle in the backoff period. A communication node desiring to transmit a QoS data frame may perform a channel state monitoring operation (e.g., carrier sensing operation) during an arbitration IFS (AIFS), and when the channel state is determined to be idle during the AIFS, the communication node may perform a random backoff procedure. The AIFS may be configured according to an access category (AC) of a data unit (e.g., protocol data unit (PDU)) included in the QoS data frame. The AC of the data unit may be as shown in Table 1 below.

TABLE 1

| Priority | AC | Description |
|---|---|---|
| Lowest | AC_BK | Background |
| | AC_BE | Best effort |
| | AC_VI | Video |
| Highest | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE.

In the random backoff procedure, the communication node may select a backoff value (e.g., a backoff counter) within a contention window according to the AC of the QoS data frame. The contention window according to the AC may be as shown in Table 2 below. CWmin may indicate a minimum value of the contention window, CWmax may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g., carrier sensing operation) in the backoff period and may transmit the QoS data frame when the channel state is determined to be idle in the backoff period.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP. In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP.

In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP. In exemplary embodiments, a transmission time of a frame may refer to a transmission start time or a transmission end time, and a reception time of a frame may refer to a reception start time or a reception end time.

In a wireless LAN system, enhanced multi-link single radio (eMLSR) operations may be supported. A communication node supporting eMLSR operations may be referred to as an eMLSR MLD, eMLSR STA MLD, eMLSR AP MLD, eMLSR AP, and/or eMLSR STA.

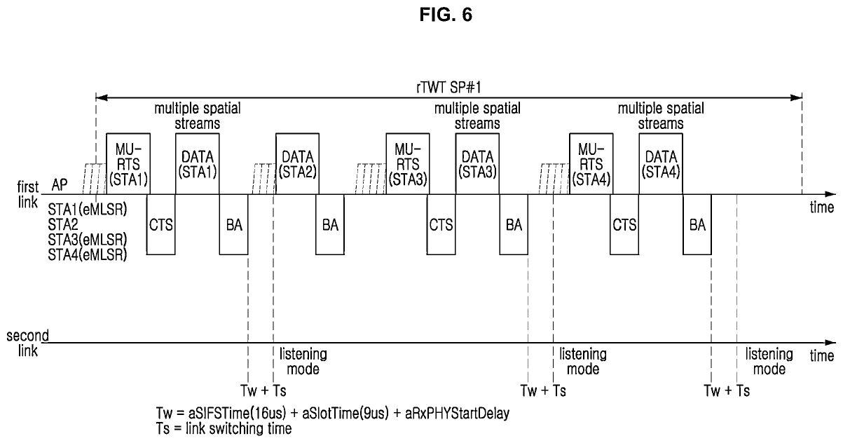

FIG. 6 is a timing diagram illustrating a first exemplary embodiment of a method for transmitting and receiving a single user frame in a restricted target wake time (rTWT) service period (SP) of an eMLSR STA.

As shown in FIG. 6, an eMLSR STA may negotiate with an AP a rTWT that restricts transmission of other STA(s) except member STA(s) in a specific service period (SP). A STA1, STA3, and STA4 may be eMLSR STAs. The eMLSR STA may obtain, from the AP, an identifier (ID) of a rTWT, a delivery time of a beacon frame indicating a start time of the rTWT SP, and/or a traffic ID (TID) of low-latency data through a negotiation procedure with the AP on one link (e.g., first link) of a multi-link. The eMLSR STA may receive the beacon frame at the delivery time of the beacon frame, and obtain rTWT SP information included in the beacon frame. The rTWT SP information may include information on the start time of the rTWT SP and/or information on a duration of the rTWT SP. The eMLSR STA may identify the rTWT SP configured by the AP.

In the present disclosure, the rTWT SP may refer to a rTWT SP #1, and the rTWT SP may be interpreted as a TWT SP. The eMLSR STA may perform low-power operations in time periods other than a time for reception of the beacon frame including the rTWT SP information and/or the rTWT SP. In the time periods in which the eMLSR STA performs low-power operations, the eMLSR STA may not be able to receive frames. If a frame (e.g., data) to be transmitted to the AP exists in the eMLSR STA, the eMLSR STA may perform a channel access operation (e.g., channel sensing operation, backoff operation, EDCA backoff operation) in the rTWT SP. Alternatively, the eMLSR STA may operate in a listening mode to receive frames from the AP. In the present disclosure, an operating mode of the STA may be classified into the listening mode and a receiving mode. That the STA operates in the listening mode may mean that the operating mode of the STA transitions from the receiving mode to the listening mode, or that the operating mode of the STA is maintained in the listening mode. That the STA operates in the receiving mode may mean that the operating mode of the STA transitions from the listening mode to the receiving mode, or that the operating mode of the STA is maintained in the receiving mode.

In the exemplary embodiment of FIG. 6, if a frame (e.g., data) to be transmitted to the STA1 (e.g., cMLSR STA) exists in the AP, the AP may transmit an initial control frame to the STA1 by performing a channel access operation in the rTWT SP. The STA1 may receive the initial control frame from the AP. The initial control frame may be a multi-user (MU)-RTS trigger frame or a buffer status report poll (BSRP) trigger frame. In the present disclosure, a MU-RTS trigger frame may refer to a MU-RTS frame, and a BSRP trigger frame may refer to a BSRP frame.

The eMLSR STA may receive the MU-RTS trigger frame from the AP, and transmit a CTS frame in response to the MU-RTS trigger frame. Alternatively, the eMLSR STA may receive the BSRP trigger frame from the AP, and transmit to the AP a buffer status report (BSR) frame including information on data (e.g., packet, frame) present in a buffer of the eMLSR STA. The BSR frame transmitted by the eMLSR STA may include information on a data frame for the TID indicated by the initial rTWT negotiation procedure between the eMLSR STA and the AP.

The eMLSR STA may receive the data frame from the AP after a short interframe space (SIFS) elapses from a time of transmitting the CTS frame or BSR frame. The eMLSR STA may transmit a response frame to the AP in response to the data frame received from the AP. In this case, the data frame may be received using multiple spatial stream(s) supported by the eMLSR STA. The eMLSR STA may transmit capability information including information on the number of multiple spatial streams supported by the eMLSR STA in an association procedure with the AP. The AP may receive the capability information from the eMLSR STA and identify the number of multiple spatial streams supported by the eMLSR STA based on the capability information. The AP may transmit the data frame considering the number of multiple spatial streams supported by the eMLSR STA.

In exemplary embodiments, the response frame may be an acknowledgment (ACK) frame or a block ACK (BA) frame. When a frame transmitted by the eMLSR STA is a frame that does not require a response frame (e.g., BA frame or ACK frame), or when a frame transmitted by the eMLSR STA is a response frame, the eMLSR STA may operate in the receiving mode (e.g., reception standby state) during a time Tw from a time of transmitting the frame. In the receiving mode, the eMLSR STA may identify whether a frame transmitted to itself exists.

The time Tw may be ‘aSIFS (16 us)+aSlotTime (9 us)+aRXPHYStartDelay’. A time Ts may be a time required for the eMLSR STA to transition from the listening mode to the receiving mode or a time required for the eMLSR STA to transition from the receiving mode to the listening mode. If there is no frame transmitted to the eMLSR STA during the time Tw, the eMLSR STA may transition to the listening mode in which the eMLSR STA waits for reception on the multi-link. The eMLSR STA may include a plurality of radio modules and one decoding module. The plurality of radio modules may perform decoding operations and reception operations for a specific initial control frame (e.g., MU-RTS frame or BSRP frame) in the listening mode. In the exemplary embodiment of FIG. 6, since the STA2 is not an eMLSR STA, the STA2 may immediately receive a data frame without receiving a MU-RTS frame or BSRP frame. Since the STA3 and STA4 are eMLSR STAs, each of the STA3 and STA4 may receive a data frame in the same manner as the frame reception procedure of the STA1 that is the cMLSR STA.

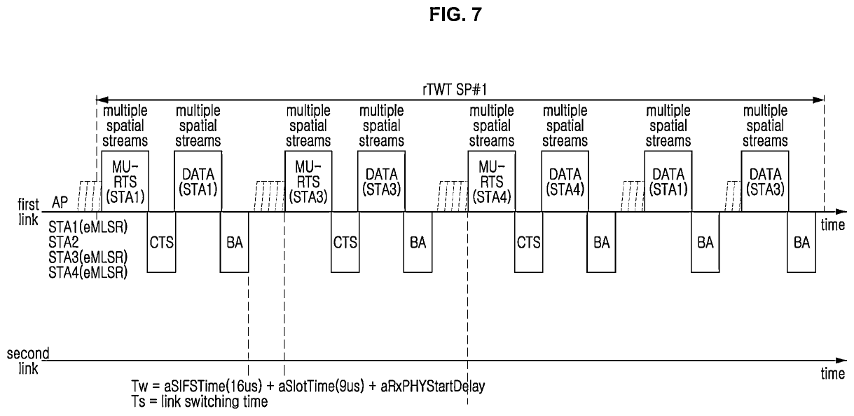

FIG. 7 is a timing diagram illustrating a second exemplary embodiment of a method for transmitting and receiving a single user frame in a rTWT SP of an eMLSR STA.

As shown in FIG. 7, an eMLSR STA may negotiate with an AP a rTWT that restricts transmission of other STA(s) except member STA(s) in a specific SP. A STA1, STA3, and STA4 may be eMLSR STAs. The eMLSR STA may obtain, from the AP, an ID of a rTWT, a delivery time of a beacon frame indicating a start time of the rTWT SP, and/or a TID of low-latency data through a negotiation procedure with the AP on one link (e.g., first link) of a multi-link. The eMLSR STA may receive the beacon frame at the delivery time of the beacon frame, and obtain rTWT SP information included in the beacon frame. The rTWT SP information may include information on the start time of the rTWT SP and/or information on a duration of the rTWT SP. The rTWT SP may refer to a rTWT SP #1, and the rTWT SP may be interpreted as a TWT SP. The eMLSR STA may perform low-power operations in time periods other than a time for reception of the beacon frame including the rTWT SP information and/or the rTWT SP. In the time periods in which the eMLSR STA performs low-power operations, the eMLSR STA may not be able to receive frames.

If a frame (e.g., data) to be transmitted to the AP exists in the eMLSR STA, the eMLSR STA may perform a channel access operation (e.g., channel sensing operation, backoff operation, EDCA backoff operation) in the rTWT SP. Alternatively, the eMLSR STA may operate in the listening mode to receive frames from the AP. In the exemplary embodiment of FIG. 7, if a frame (e.g., data) to be transmitted to the STA1 (e.g., cMLSR STA) exists in the AP, the AP may transmit an initial control frame to the STA1 by performing a channel access operation in the rTWT SP. STA1 may receive the initial control frame from the AP. The initial control frame may be a MU-RTS trigger frame or a BSRP trigger frame. A MU-RTS trigger frame may refer to a MU-RTS frame, and a BSRP trigger frame may refer to a BSRP frame.

The eMLSR STA may receive the MU-RTS trigger frame from the AP, and transmit a CTS frame in response to the MU-RTS trigger frame. Alternatively, the eMLSR STA may receive the BSRP trigger frame from the AP, and transmit to the AP a BSR frame including information on data (e.g., packet, frame) present in a buffer of the eMLSR STA. The BSR frame transmitted by the eMLSR STA may include information on a data frame for the TID indicated by the initial rTWT negotiation procedure between the eMLSR STA and the AP.

The eMLSR STA may receive the data frame from the AP after a SIFS elapses from a time of transmitting the CTS frame or BSR frame. The eMLSR STA may transmit a response frame to the AP in response to the data frame received from the AP. In this case, the data frame may be received using multiple spatial stream(s) supported by the eMLSR STA. The eMLSR STA may transmit capability information including information on the number of multiple spatial streams supported by the eMLSR STA in an association procedure with the AP. The AP may receive the capability information from the eMLSR STA and identify the number of multiple spatial streams supported by the eMLSR STA based on the capability information. The AP may transmit the data frame considering the number of multiple spatial streams supported by the eMLSR STA.

The eMLSR STA operating in the rTWT SP may not perform a reception standby operation for transitioning to the listening mode after transmission of the response frame for the data frame. For example, the eMLSR STA may not operate in the receiving mode (e.g., reception standby state). In the reception standby state for transitioning to the listening mode, the eMLSR STA may identify whether there is a frame transmitted to the eMLSR STA during a time Tw to be described later, after transmission of the response frame for the data frame. The eMLSR STA operating in the rTWT SP may operate in the receiving mode without transitioning to the listening mode during the rTWT SP on a link on which the initial control frame (e.g., MU-RTS frame) transmitted by the AP was received. In the receiving mode, the eMLSR STA may be able to receive data from the AP. The eMLSR STA operating in the receiving mode may wait to receive additional data from the AP. If reception of the initial data is successful, the receiving mode may be maintained during the rTWT SP. When decoding of the received data is performed and the response frame for the data is transmitted, reception of the data may be determined to be successful. The time Tw may be ‘aSIFS (16 us)+aSlotTime (9 us)+aRXPHYStartDelay’. The AP may transmit a data frame including a listening mode transition indicator to the eMLSR STA. In this case, the eMLSR STA may receive the data frame including the listening mode transition indicator from the AP, and transmit a response frame for the data frame to the AP. When the data frame includes the listening mode transition indicator, the eMLSR STA may operate in the listening mode after a time (Tw+Ts) elapses from a time of transmitting the response frame. The operating mode of the eMLSR STA may transition from the receiving mode to the listening mode. The listening mode transition indicator may be indicated using a more data field, an end of service period (EOSP) field, a BSR control field, a BSR frame (e.g., BSR initial control frame), a more trigger frame (TF) field, and/or a more random access-resource unit (RA-RU) field.

The eMLSR STA may include a plurality of radio modules and one decoding module. The plurality of radio modules may perform decoding operations and reception operations for a specific control frame (e.g., MU-RTS frame or BSRP frame) in the listening mode. The specific control frame may be an initial control frame. In the receiving mode, the eMLSR STA may perform reception/decoding operations for multiple spatial streams using the plurality of radio modules. In the exemplary embodiment of FIG. 7, the STA1, which is an eMLSR STA, may receive a control frame and a data frame of the AP to receive downlink traffic of the AP, transmit a response frame for the received data frame, receive a control frame after transmission of the response frame, and then operate in the receiving mode on the first link on which the rTWT SP is configured. The first link may be a primary link on which the eMLSR STA(s) receive beacon frames of the AP. The primary link may be a link on which the rTWT SP is configured.

Since the STA3 and STA4 are eMLSR STAs, each of the STA3 and STA4 may receive a data frame in the same manner as the frame reception procedure of the STA1 that is an eMLSR STA. For example, the STA3 and STA4 may receive an initial control frame from the AP, and if a data frame including a listening mode transition indicator is not received on the first link on which the initial control frame is received, the STA3 and STA4 may operate in the receiving mode until the rTWT SP is terminated. The eMLSR STA may receive a data frame once after receiving a first MU-RTS trigger frame or a first BSRP trigger frame within the rTWT SP, and may maintain the receiving mode after receiving the data frame. In this case, the AP may transmit downlink data to the STAs (e.g., STA1, STA3, STA4) operating in the receiving mode within the rTWT SP without transmitting an initial control frame (e.g., MU-RTS frame or BSRP frame).

The eMLSR STA may start a frame reception procedure initiated by the first MU-RTS trigger frame within the rTWT SP, and maintain the receiving mode after receiving the first data frame once from the AP. In this case, the eMLSR STA may operate in the listening mode after termination of the rTWT SP. The operating mode of the eMLSR STA may transition from the receiving mode to the listening mode. A time required for transitioning to the listening mode may be Tw+Ts. Alternatively, when there is no need to wait for reception of a new frame, a time required for transitioning to the listening mode may be Ts.

The time Ts may be a value negotiated in the initial association procedure between the STA and the AP. The STA may maintain the receiving mode during the rTWT SP. A frame to be transmitted to the STA after termination of the rTWT SP may occur at the AP. In this case, the AP may transmit the frame to the STA after the transition time (e.g., Tw+Ts or Ts) elapses from an end time of the rTWT SP.

In the exemplary embodiment of FIG. 7, the AP may perform a channel access operation to transmit the data frame to the STA1 through multiple spatial streams in the rTWT SP #1, transmit a MU-RTS frame if the channel access operation is successful, and receive a CTS frame from the STA1. The AP may transmit the data frame to the STA1 after a SIFS elapses from a time of receiving the CTS frame, and may receive a response frame for the data frame after a SIFS elapses from a time of transmitting the data frame. The STA1 may receive the data frame once after receiving the first MU-RTS trigger frame or the first BSRP trigger frame within the rTWT SP. Therefore, the STA1 may maintain the receiving mode until an end time of the rTWT SP or a time of receiving an rTWT SP termination indicator without transitioning to the listening mode after transmission of the response frame for the data frame.

The AP may transmit data frames to the STA3 and STA4 within the rTWT SP. Thereafter, data to be transmitted to the STA1 may occur at the AP. Since the STA1 maintains the receiving mode within the rTWT SP, the AP may transmit a data frame to the STA1 without transmitting a MU-RTS frame (e.g., MT-RTS trigger frame) after performing a channel access operation. Each of the STA3 and STA4 may receive the data frame once after receiving the first MU-RTS trigger frame or the first BSRP trigger frame within the rTWT SP. Therefore, the STA3 and STA4 may maintain the receiving mode until the end time of the rTWT SP or a time of receiving a rTWT SP termination indicator without transitioning to the listening mode after transmission of the response frame for the data frame. Similarly to transmitting additional data to the STA1, when data frames to be transmitted to the STA3 and STA4 occur at the AP, the AP may transmit the data frames without transmitting an initial control frame after performing a channel access operation within the rTWT SP.

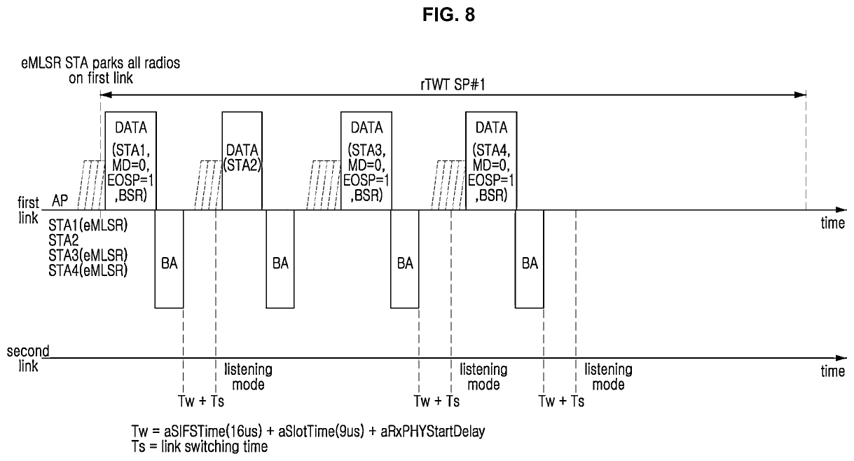

FIG. 8 is a timing diagram illustrating a third exemplary embodiment of a method for transmitting and receiving a single user frame in a rTWT SP of an eMLSR STA.

As shown in FIG. 8, an eMLSR STA may negotiate with an AP a rTWT that restricts transmission of other STA(s) except member STA(s) in a specific SP. A STA1, STA3, and STA4 may be eMLSR STAs. The eMLSR STA may obtain, from the AP, an ID of a rTWT, a delivery time of a beacon frame indicating a start time of the rTWT SP, and/or a TID of low-latency data through a negotiation procedure with the AP on one link (e.g., first link) of a multi-link. The eMLSR STA may receive the beacon frame at the delivery time of the beacon frame, and obtain rTWT SP information included in the beacon frame. The rTWT SP information may include information on the start time of the rTWT SP and/or information on a duration of the rTWT SP. The rTWT SP may refer to a rTWT SP #1, and the rTWT SP may be interpreted as a TWT SP. The eMLSR STA may perform low-power operations in time periods other than a time for reception of the beacon frame including the rTWT SP information and/or the rTWT SP. In the time periods in which the eMLSR STA performs low-power operations, the eMLSR STA may not be able to receive frames.

The eMLSR STA may include a plurality of radio modules and one decoding module. The plurality of radio modules may perform decoding operations and reception operations for a specific control frame (e.g., MU-RTS frame or BSRP frame) in the listening mode.

The specific control frame may be an initial control frame. In the receiving mode, the eMLSR STA may perform reception/decoding operations for multiple spatial streams using the plurality of radio modules. If there is a frame to be transmitted to the AP, the eMLSR STA may perform a channel access operation (e.g., channel sensing operation, backoff operation, EDCA backoff operation) for communication with the AP during the rTWT SP. Alternatively, the eMLSR STA may operate in the receiving mode using the plurality of radio modules in the rTWT SP.

In the exemplary embodiment of FIG. 8, when the rTWT SP to which the eMLSR STA belongs is initiated, the eMLSR STA may switch the radio modules to the link on which the rTWT SP is configured until a start time of the rTWT SP, and operate in the receiving mode at the start time of the rTWT SP. Since the AP knows that the eMLSR STA operates in the receiving mode from the start time of the rTWT SP, the AP may transmit a data frame using multiple spatial streams without transmitting a MU-RTS frame or BSRP frame, which is an initial control frame. The eMLSR STA may receive the data frame using multiple spatial streams without receiving a MU-RTS frame or BSRP frame within the rTWT SP. The eMLSR STA may maintain the receiving mode until the end time of the rTWT SP if a listening mode transition indicator is not received during the rTWT SP. The

AP may deliver the data frame to the eMLSR STA within the rTWT SP. Thereafter, if there is no additional data to be transmitted in the rTWT SP, the AP may indicate the eMLSR STA to transition to the listening mode on the multi-link. The data frame transmitted by the AP to the eMLSR STA may include a listening mode transition indicator (e.g., more data (MD)=0, EOSP=1, or BSR=0).

When the rTWT SP is terminated, the operating mode of the eMLSR STA may transition from the receiving mode to the listening mode. A transition time of the operating mode may be Tw+Ts or Ts. The link on which the rTWT SP is configured may be a primary link on which the eMLSR STA receives a beacon frame broadcasting information on the AP. The primary link may be the link on which the rTWT SP is configured. The eMLSR STA may perform transmission and reception operations on the primary link during the rTWT SP. The AP may configure the rTWT SP so that the rTWT SP does not overlap with a rTWT SP of another link on which the AP MLD affiliated with the AP operates. The AP may configure the rTWT SP after the transition time (e.g., Tw+Ts or Ts) of the operating mode of the eMLSR STA from an end time of the rTWT SP configured on another link on which the AP MLD affiliated with the AP operates.

In the exemplary embodiment of FIG. 8, the STA1, STA3, and STA4 which are cMLSR STAs may switch radio modules waiting to receive on other links to the first link, and operate in the receiving mode to receive data using multiple spatial streams. In this case, the time Ts (e.g., minimum time Ts), which is the transition time of the operating mode, may be required before starting the rTWT SP. The transition time of the operating mode may vary depending on the eMLSR STAs. If a data frame to be transmitted to the STA1, which is the eMLSR STA, exists in the AP, the AP may transmit the data frame to the STA1 using multiple spatial streams without transmitting a MU-RTS frame or BSRP frame after performing a channel access operation in the rTWT SP. The STA1 may receive the data frame from the AP using multiple spatial streams supported by the STA1. The eMLSR STA may transmit a response frame (e.g., ACK frame or BA frame) for the data frame received from the AP to the AP.

The eMLSR STA may transmit capability information including information on the number of multiple spatial streams supported by the eMLSR STA in an association procedure with the AP. The AP may receive the capability information from the eMLSR STA and identify the number of multiple spatial streams supported by the eMLSR STA based on the capability information. The AP may transmit the data frame considering the number of multiple spatial streams supported by the eMLSR STA.

The eMLSR STA may maintain the receiving mode until an end time of the rTWT SP. If the data frame received by the eMLSR STA includes a listening mode transition indicator (e.g., more data (MD)=0, EOSP=1, or BSR=0), the eMLSR STA may operate in the listening mode after transmitting a response frame for the data frame. That is, the operating mode of the eMLSR STA may transition from the receiving mode to the listening mode.

When the listening mode transition indicator is received from the AP, the eMLSR STA may operate in the listening mode. The transition to the listening mode may be indicated using a more data field, EOSP field, BSR control field, and/or BSR frame (e.g., BSR initial control frames). For example, a more data field included in a frame control field within a MAC header of a single MAC protocol data unit (MPDU) or aggregated (A)-MPDU of the data frame transmitted by the AP to the eMLSR STA may be used to indicate the transition to the listening mode. If the more data field included in the data frame received by the eMLSR STA from the AP within the rTWT SP is set to 0, the eMLSR STA may determine that the more data field indicates the transition to the listening mode, and operate in the listening mode. If the more data field included in the data frame received by the eMLSR STA from the AP within the rTWT SP is set to 1, the eMLSR STA may maintain the receiving mode.

As another method, an EOSP field included in a QoS control field within the MAC header of the single MPDU or A-MPDU of the frame (e.g., data frame) transmitted by the AP to the eMLSR STA may be used to indicate the transition to the listening mode. If the EOSP field included in the frame received from the AP within the rTWT SP by the eMLSR STA is set to 1, the eMLSR STA may determine that the EOSP field indicates the transition to the listening mode, and operate in the listening mode. If the EOSP field included in the frame received by the eMLSR STA from the AP within the rTWT SP is set to 0, the cMLSR

STA may maintain the receiving mode.

As another method, a BSR control field included in a HT control field within the MAC header of the single MPDU or A-MPDU of the frame (e.g., data frame) transmitted by the AP to the eMLSR STA may be used to indicate the transition to the listening mode. A queue size field included in the QoS control field within the MAC header of the single MPDU or A-MPDU of the frame (e.g., data frame) transmitted by the AP to the eMLSR STA may be used to indicate the transition to the listening mode. The AP may use the BSR control field and/or queue size field to indicate presence or absence of downlink traffic to be transmitted to the eMLSR STA. When the eMLSR STA receives a frame including information indicating that downlink traffic does not exist from the AP within the rTWT SP, the eMLSR STA may operate in the listening mode. When the eMLSR STA receives a frame including information indicating that downlink traffic exists from the AP within the rTWT SP or when the eMLSR STA fails to receive information on downlink traffic, the CMLSR STA may maintain the receiving mode. Alternatively, if the listening mode transition indicator is not received, the eMLSR STA may maintain the receiving mode.

In the exemplary embodiment of FIG. 8, the STA1 that is the eMLSR STA may operate in the receiving mode in the rTWT SP. Therefore, the eMLSR STA may receive the data frame from the AP using multiple spatial streams without receiving a MU-RTS frame or BSRP frame. The STA1 may operate in the listening mode based on the listening mode transition indicator received from the AP. That is, the operating mode of STA1 may transition from the receiving mode to the listening mode. The STA3 and STA4, which are eMLSR STAs, may operate in the receiving mode during the rTWT SP similarly to the STA1. Therefore, each of the STA3 and STA4 may receive a data frame from the AP using multiple spatial streams without receiving a MU-RTS frame or BSRP frame. The STA3 and STA4 may operate in the listening mode based on a listening mode transition indicator received from the AP.

Since the STA2 is not an eMLSR STA, the STA2 may receive a data frame of the AP without separate configuration. The AP may configure a TXOP when initially transmitting a data frame in the rTWT SP. The TXOP may be configured as a time required for reception and/or transmission operations of all STAs communicating with the AP. The AP may set a value of a duration field included in a MAC header of the data frame transmitted to the STA1 to include up to a time required for reception of a response frame of the STA4. The TXOP may be configured based on the value of the duration field.

In the exemplary embodiment of FIG. 8, the STA1, STA3, and STA4 which are eMLSR STAs may not be able to detect a medium while performing listening operations. Accordingly, the STA1, STA3, and STA4 may operate (c.g., start) a MediumSyncDelay timer, which is a timer for synchronizing the medium before frame transmission. The STAs may not be able to transmit frames while the MediumSyncDelay timer is running. Accordingly, the STA1, STA2, and STA4 may not transmit an uplink frame immediately. The MediumSyncDelay timer may be released when a frame is received. That is, when a frame is received, the operation of the MediumSyncDelay timer may be stopped. The MediumSyncDelay timer may be initially set to a maximum PPDU length, and the maximum PPDU length may be a preset value. The STA1, STA3, and STA4 may not be able to transmit frames due to the MediumSyncDelay timer in the rTWT SP #1. Accordingly, the AP may release the MediumSyncDelay timer by transmitting a MU-RTS frame or BSRP frame, which is an initial control frame, before or immediately after the rTWT SP of the first link starts.

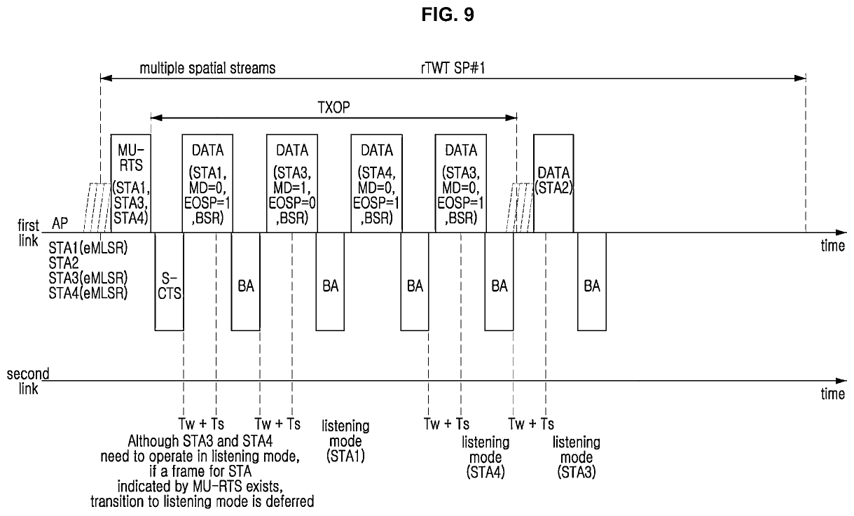

FIG. 9 is a timing diagram illustrating a fourth exemplary embodiment of a method for transmitting and receiving a single user frame in a rTWT SP of an eMLSR STA. As shown in FIG. 9, an eMLSR STA may negotiate with an AP a rTWT that restricts transmission of other STA(s) except member STA(s) in a specific SP. A STA1, STA3, and STA4 may be cMLSR STAs. The eMLSR STA may obtain, from the AP, an ID of a rTWT, a delivery time of a beacon frame indicating a start time of the rTWT SP, and/or a TID of low-latency data through a negotiation procedure with the AP on one link (e.g., first link) of a multi-link. The eMLSR STA may receive the beacon frame at the delivery time of the beacon frame, and obtain rTWT SP information included in the beacon frame. The rTWT SP information may include information on the start time of the rTWT SP and/or information on a duration of the rTWT SP. The rTWT SP may refer to a rTWT SP #1, and the rTWT SP may be interpreted as a TWT SP. The eMLSR STA may perform low-power operations in time periods other than a time for reception of the beacon frame including the rTWT SP information and/or the rTWT SP. In the time periods in which the eMLSR STA performs low-power operations, the eMLSR STA may not be able to receive frames.

The eMLSR STA may include a plurality of radio modules and one decoding module. The plurality of radio modules may perform decoding operations and reception operations for a specific control frame (e.g., MU-RTS frame or BSRP frame) in the listening mode. In the receiving mode, the eMLSR STA may perform reception/decoding operations for multiple spatial streams using the plurality of radio modules. If there is a frame to be transmitted to the AP, the eMLSR STA may perform a channel access operation (e.g., channel sensing operation, backoff operation, EDCA backoff operation) for communication with the AP during the rTWT SP. Alternatively, the eMLSR STA may operate in the listening mode to receive frames from the AP. The AP may set the rTWT SP to overlap or be identical to a rTWT SP of another link on which the AP MLD affiliated with the AP operates.

As shown in FIG. 9, when frames to be transmitted to the STA1, STA3, and STA4 that are eMLSR STAs exist in the AP, the AP may perform a channel access operation (c.g., channel sensing operation, backoff operation, EDCA backoff operation), and then transmit an initial control frame notifying a start of a data transmission procedure to the cMLSR STAs (e.g., STA1, STA3, and STA4). The initial control frame may be a MU-RTS trigger frame or a BSRP trigger frame. The AP may transmit one initial control frame (e.g., MU-RTS trigger frame or BSRP trigger frame) to a plurality of eMLSR STAs. User information (i.e., user info) of the initial control frame may include association identifiers (AIDs) of the target eMLSR STAs.

When the MU-RTS trigger frame is received from the AP, the eMLSR STAs may simultaneously transmit CTS frames (e.g., CTS control frames) in response to the MU-RTS trigger frames. The CTS frames transmitted simultaneously may be referred to as a simultaneous(S)-CTS frame. When the BSRP trigger frame is received from the AP, the eMLSR STAs may transmit BSR frames including information on packets (e.g., data, frames) existing in buffers. The BSR frames may be transmitted in an orthogonal frequency division multiple access (OFDMA) scheme by respectively using resource units (RUs) indicated by the BSRP trigger frame.

The BSR frame transmitted by the eMLSR STA may include information on a data frame of a priority TID for the rTWT indicated in the initial rTWT negotiation procedure between the eMLSR STA and the AP. The eMLSR STA may receive the data frame from the AP after a SIFS elapses from a time of transmitting the CTS frame or BSR frame. In this case, the data frame may be received using multiple spatial streams supported by the eMLSR STA. The eMLSR STA may transmit capability information including information on the number of multiple spatial streams supported by the eMLSR STA in an association procedure with the AP. The AP may receive the capability information from the eMLSR STA and identify the number of multiple spatial streams supported by the eMLSR STA based on the capability information. The AP may transmit the data frame considering the number of multiple spatial streams supported by the eMLSR STA.

The eMLSR STA may receive the data frame from the AP and transmit a response frame for the data frame to the AP. When the eMLSR STA receives the data frame which is to be received after a SIFS elapses from a time of transmitting the CTS frame for the MU-RTS frame received from the AP or a time of transmitting the BSR frame for the BSRP frame received from the AP, the eMLSR STA may maintain the receiving mode. In addition, when data frame(s) of the eMLSR STA(s) indicated by user information of the MU-RTS frame or BSRP frame are received, the eMLSR STA may maintain the receiving mode.

Since the user information indicates an AID and the data frame includes a MAC address, the STA may not be able to identify a STA indicated by the MU-RTS frame or BSRP frame. Therefore, the AP may transmit the MU-RTS frames to STAs by respectively using RUs based on the OFDMA scheme. In this case, a recipient address of the MU-RTS frame transmitted to the STA in each RU is a unicast MAC address, and thus the STA may know all STAs indicated by the MU-RTS frame.

Even when the eMLSR STAs receive the MU-RTS frames in the OFDMA scheme, CTS frames transmitted by the cMLSR STAs may be a S-CTS frame. That is, the eMLSR

STAs may simultaneously transmit the CTS frames (e.g., S-CTS frame). In the transmission procedure of the MU-RTS frames, the AP may set a time required for transmission to the plurality of eMLSR STAs as a value of a duration field. A TXOP may be configured based on the value of the duration field. The TXOP may be configured when the CTS frame for the MU-RTS frame is received or when the BSR frame for the BSRP frame is received.

The AP may transmit data frames to the eMLSR STAs at SIFS intervals without performing a channel access operation within the TXOP. The STA2 may not be an eMLSR STA. The STA2 may not be a recipient of a data frame within the TXOP configured by the MU-RTS frame. Therefore, the AP may transmit a data frame to the STA2 after performing a channel access operation after termination of the TXOP configured by the MU-RTS frame.

As shown in FIG. 9, the TXOP may be configured for the STA1, STA3, and STA4 that transmitted the CTS frames for the MU-RTS frame of the AP. Alternatively, the AP may configure the TXOP by transmitting another frame (e.g., CTS-to-Self frame, data frame, trigger frame) before transmitting the MU-RTS frame. The eMLSR STAs indicated by the MU-RTS frame may operate in the receiving mode. The eMLSR STA operating in the receiving mode may receive the data frame using multiple spatial streams without receiving additional MU-RTS frame or additional BSRP frame. Since all eMLSR STAs indicated as reception targets by user information included in the MU-RTS frame or BSRP frame operate in the receiving mode, the MU-RTS frame(s) or BSRP frame(s) may not need to be transmitted in the OFDMA scheme.

The STA1 and STA4 may each receive a data frame and a separate listening mode transition indicator from the AP, and may identify that no downlink traffic exists based on the listening mode transition indicator. The listening mode transition indicator may be information indicated by at least one of a more data (MD) bit, EOSP bit, BSR control, or queue size field as in the exemplary embodiment of FIG. 8. The STA1 and STA4 may operate in the listening mode after transmitting a response frame for the data frame to the AP. The STA3 may receive the data frame and a separate listening mode transition indicator from the AP, and may identify that downlink traffic exists based on the listening mode transition indicator. The STA3 may operate in the receiving mode to receive downlink traffic after transmitting a response frame for the data frame to the AP. The STA3 may identify that no additional downlink traffic exists based on an indication of next downlink traffic received from the AP. The STA3 may operate in the listening mode after transmitting a response frame to the AP. That is, the operating mode of the STA3 may transition from the receiving mode to the listening mode. The STA may receive a BSRP frame, which is an initial control frame, from the AP, and may transmit a BSR frame to the AP in response to the BSRP frame.

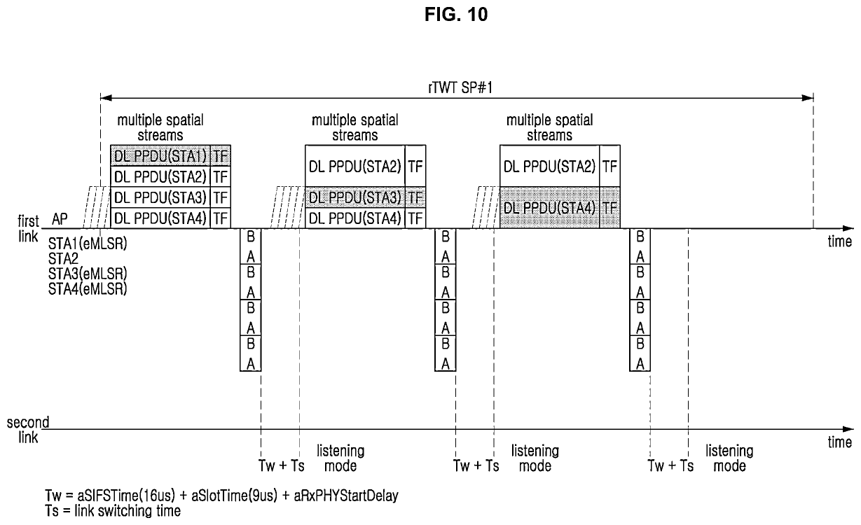

FIG. 10 is a timing diagram illustrating a first exemplary embodiment of a method for transmitting and receiving a multi-user frame in a rTWT SP of an eMLSR STA.

As shown in FIG. 10, an eMLSR STA may negotiate with an AP a rTWT that restricts transmission of other STA(s) except member STA(s) in a specific SP. A STA1, STA3, and STA4 may be eMLSR STAs. The eMLSR STA may obtain, from the AP, an ID of a rTWT, a delivery time of a beacon frame indicating a start time of the rTWT SP, and/or a TID of low-latency data through a negotiation procedure with the AP on one link (c.g., first link) of a multi-link. The eMLSR STA may receive the beacon frame at the delivery time of the beacon frame, and obtain rTWT SP information included in the beacon frame. The rTWT SP information may include information on the start time of the rTWT SP and/or information on a duration of the rTWT SP. The rTWT SP may refer to a rTWT SP #1, and the rTWT SP may be interpreted as a TWT SP. The eMLSR STA may perform low-power operations in time periods other than a time for reception of the beacon frame including the rTWT SP information and/or the rTWT SP. In the time periods in which the eMLSR STA performs low-power operations, the eMLSR STA may not be able to receive frames.

The eMLSR STA may include a plurality of radio modules and one decoding module. The plurality of radio modules may perform decoding operations and reception operations for a specific control frame (c.g., MU-RTS frame or BSRP frame) in the listening mode. The specific control frame may be an initial control frame. In the receiving mode, the eMLSR STA may perform reception/decoding operations for multiple spatial streams using the plurality of radio modules. If there is a frame to be transmitted to the AP, the eMLSR STA may perform a channel access operation (e.g., channel sensing operation, backoff operation, EDCA backoff operation) for communication with the AP during the rTWT SP. Alternatively, the eMLSR STA may operate in the receiving mode using a plurality of radio modules on a link on which the rTWT SP is configured.

When the rTWT SP is terminated, the operating mode of the eMLSR STA may transition from the receiving mode to the listening mode. The link on which the rTWT SP is configured may be referred to as a primary link on which the eMLSR STA receives a beacon frame broadcasting information on the AP. The AP may configure the rTWT SP so that the rTWT SP does not overlap with a rTWT SP of another link on which the AP MLD affiliated with the AP operates. The AP may configure the rTWT SP after the time Ts from an end time of the rTWT SP of another link on which the AP MLD affiliated with the AP operates. The time Ts may be a time required for transition of the operating mode of the eMLSR STA. For example, the time Ts may be a time required for transition from the listening mode to the receiving mode or a time required for transition from the receiving mode to the listening mode.

In the exemplary embodiment of FIG. 10, the operating mode of the eMLSR STAs (c.g., STA1, STA3, STA4) may transition from the listening mode to the receiving mode at a start time of the rTWT SP. The STA1, STA3, and STA4 may receive a data frame from the AP using multiple spatial streams from the start time of the rTWT SP without receiving a MU-RTS frame or transmitting a CTS frame. The MU-RTS frame may be an initial control frame. If frame(s) to be transmitted to the eMLSR STAs (e.g., STA1, STA3, STA4) and non-cMLSR STAs (e.g., STA2) exist in the AP, the AP may perform a channel access operation in the rTWT SP, and then transmit the data frames to the eMLSR STAs and non-cMLSR STAs using multiple spatial streams in the OFDMA scheme.

The number of multiple spatial streams used by the AP may be the same as the number of multiple spatial streams supported by the STA(s) receiving the frames transmitted in the OFDMA scheme. The eMLSR STA may receive the data frame from the AP using multiple spatial streams less than or equal to the maximum number of multiple spatial streams that it supports. The eMLSR STA may transmit a response frame (e.g., ACK frame or BA frame) for the data frame received from the AP to the AP. The eMLSR STA may transmit capability information including information on the number of multiple spatial streams supported by the eMLSR STA in an association procedure with the AP. The AP may receive the capability information from the eMLSR STA, and identify the number of multiple spatial streams supported by the eMLSR STA based on the capability information.

The eMLSR STA may maintain the receiving mode after transmission of the frame. The eMLSR STA may wait to receive additional data from the AP by operating in the receiving mode during the rTWT SP. When a listening mode transition indicator is received from the AP, the operating mode of the eMLSR STA may transition from the receiving mode to the listening mode. The transition to the listening mode may be indicated using a more data field, an EOSP field, a BSR control field, a BSR frame (e.g., BSR initial control frame), a more TF field, and/or a more RA-RU field. The more data field, EOSP field, BSR control field, BSR frame (e.g., BSR initial control frame), more TF field, and/or more RA-RU field may be used as the listening mode transition indicator. A method of indicating the transition to the listening mode using the more data field, EOSP field, BSR control field, and/or BSR frame (e.g., BSR initial control frame) may be the same as the methods described in FIG. 8 above.

transmitted by the AP for triggering of a response frame in a downlink traffic transmission procedure or a trigger frame transmitted for allocation of multiple users in an uplink traffic transmission procedure may be used to indicate the transition to the listening mode. When a trigger frame including a more TF field set to 0 is received within the rTWT SP, the eMLSR STA may determine that the more TF field indicates transition to the listening mode, and may operate in the listening mode accordingly. When a trigger frame including a more TF field set to 1 is received within the rTWT SP, the eMLSR STA may maintain the receiving mode.

A more TF field included in a common information field and a more RA-RU field included in a user information field of a trigger frame transmitted by the AP for triggering of a response frame in a downlink traffic transmission procedure or a trigger frame transmitted for allocation of multiple users in an uplink traffic transmission procedure may be used to indicate the transition to the listening mode. When a trigger frame including a more TF field set to 0 is received within the rTWT SP, the eMLSR STA may determine that the more TF field indicates the transition to the listening mode, and may operate in the listening mode to wait for reception of a MU-RTS frame or BSRP frame on the multi-link. When a trigger frame including a more TF field set to 1 and a more RA-RU field set to 0 is received in the rTWT SP, the eMLSR STA may determine that the fields indicate the transition to the listening mode, and may operate in the listening mode to wait for reception of a MU-RTS frame or BSRP frame on the multi-link. When a trigger frame including a more TF field set to 1 and a more RA-RU field set to 1 is received within the rTWT SP, the eMLSR STA may maintain the receiving mode during the rTWT SP.

In the exemplary embodiment of FIG. 10, since the eMLSR STAs (e.g., STA1, STA3, STA4) operate in the receiving mode during the rTWT SP, the eMLSR STAs may receive data frames of the AP without receiving an initial control frame. The initial control frame may be a MU-RTS frame or a BSRP frame. The STA1 may operate in the listening mode based on a listening mode transition indicator (e.g., more TF field, more RA-RU field) received from the AP. That is, the operating mode of the STA1 may transition from the receiving mode to the listening mode. The STA3 and STA4 may maintain the receiving mode based on the listening mode transition indicator received from the AP. The STA3 and STA4 may receive a next data frame of the AP without receiving an initial control frame of the AP. The STA3 may operate in the listening mode based on the listening mode transition indicator received from the AP. That is, the operating mode of the STA3 may transition from the receiving mode to the listening mode. The STA4 may maintain the receiving mode based on the listening mode transition indicator received from the AP. Since the STA4 operates in the receiving mode, the STA4 may receive a next data frame of the AP without receiving an initial control frame (e.g., MU-RTS frame or BSRP frame) of the AP. The STA4 may operate in the listening mode based on the listening mode transition indicator received from the AP. That is, the operating mode of STA4 may transition from the receiving mode to the listening mode.

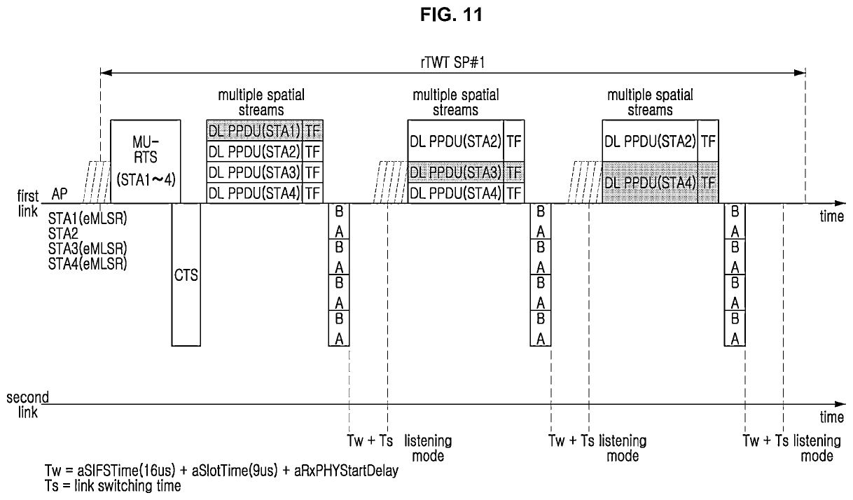

FIG. 11 is a timing diagram illustrating a second exemplary embodiment of a method for transmitting and receiving a multi-user frame in a rTWT SP of an eMLSR STA.

As shown in FIG. 11, an eMLSR STA may negotiate with an AP a rTWT that restricts transmission of other STA(s) except member STA(s) in a specific SP. A STA1, STA3, and STA4 may be eMLSR STAs. The eMLSR STA may obtain, from the AP, an ID of a rTWT, a delivery time of a beacon frame indicating a start time of the rTWT SP, and/or a TID of low-latency data through a negotiation procedure with the AP on one link (e.g., first link) of a multi-link. The eMLSR STA may receive the beacon frame at the delivery time of the beacon frame, and obtain rTWT SP information included in the beacon frame. The rTWT SP information may include information on the start time of the rTWT SP and/or information on a duration of the rTWT SP. The rTWT SP may refer to a rTWT SP #1, and the rTWT SP may be interpreted as a TWT SP. The eMLSR STA may perform low-power operations in time periods other than a time for reception of the beacon frame including the rTWT SP information and/or the rTWT SP. In the time periods in which the eMLSR STA performs low-power operations, the eMLSR STA may not be able to receive frames.

The eMLSR STA may include a plurality of radio modules and one decoding module. The plurality of radio modules may perform decoding operations and reception operations for a specific control frame (e.g., MU-RTS frame or BSRP frame) in the listening mode.

The specific control frame may be an initial control frame. In the receiving mode, the eMLSR STA may perform reception/decoding operations for multiple spatial streams using the plurality of radio modules. If there is a frame to be transmitted to the AP, the eMLSR STA may perform a channel access operation (e.g., channel sensing operation, backoff operation, EDCA backoff operation) for communication with the AP during the rTWT SP. Alternatively, the eMLSR STA may operate in the listening mode to receive frames from the AP.

The AP may configure the rTWT SP to overlap or be identical to a rTWT SP of another link on which the AP MLD affiliated with the AP operates. In the exemplary embodiment of FIG. 11, if there are frame(s) to be transmitted to the eMLSR STA (c.g., STA1, STA3, STA4) and non-eMLSR STAs (e.g., STA2) in the AP, the AP may perform a channel access operation in the rTWT SP, and then transmit an initial control frame to the STA1, STA2, STA3, and STA4. The initial control frame may be a MU-RTS trigger frame or a BSRP trigger frame. When the MU-RTS trigger frame is received from the AP, the

STAs including eMLSR STAs may simultaneously transmit CTS frames (e.g., CTS control frames, S-CTS frame). When the BSRP trigger frame is received from the AP, the eMLSR STAs may transmit BSR frames including information on packets (e.g., data, frames) existing in the buffer. The BSR frames may be transmitted in the OFDMA scheme by using respective RUs indicated by the BSRP trigger frame.

The BSR frame transmitted by the eMLSR STA may include information on a data frame of a TID for the rTWT indicated by an initial rTWT negotiation procedure between the eMLSR STA and the AP. The eMLSR STA may maintain the receiving mode during a period from a time of transmitting the CTS frame or BSR frame to an end time of the rTWT SP or a period indicated by a duration field included in a MAC header of the MU-RTS frame or BSR frame. The eMLSR STA may receive the data frame from the AP after a SIFS elapses from a time of transmitting the CTS frame or BSR frame by using multiple spatial streams less than or equal to the maximum number of multiple spatial streams supported by the eMLSR STA. The eMLSR STA may receive the data frame from the AP and transmit a response frame for the data frame to the AP. The eMLSR STA may transmit capability information including information on the number of multiple spatial streams supported by the eMLSR STA in an association procedure with the AP. The AP may receive the capability information from the eMLSR STA and identify the number of multiple spatial streams supported by the eMLSR STA based on the capability information.

In the exemplary embodiment of FIG. 11, the eMLSR STA may operate in the receiving mode in a period from a time of receiving the AP's initial control frame (e.g., MU-RTS trigger frame or BSRP trigger frame) to the end time of the rTWT SP, in a period from a time of transmitting the CTS frame to the end time of the rTWT SP, or during a TXOP configured by the initial control frame. The link on which the eMLSR STA operates in the receiving mode may be the first link on which the initial control frame is transmitted and received. The initial control frame may be a MU-RTS frame or a BSRP frame. The eMLSR STAs operating in the receiving mode may receive the data frames from the AP. The AP may transmit the data frames to the STA1, STA2, STA3, and STA4 in the OFDMA scheme.

When a listening mode transition indicator for the STA1 is received from the AP, the STA1 may operate in the listening mode based on the listening mode transition indicator. For example, the listening mode transition indicator may be information indicated by at least one of a more TF field or more RA-RU field in the exemplary embodiment of FIG. 10. When the listening mode transition indicators for the STA3 and STA4 are received from the AP, the STA3 and STA4, which are eMLSR STAs, may maintain the receiving mode based on the listening mode transition indicators. The STA3 and STA4 may receive the AP's next data frame without receiving the AP's initial control frame. When a listening mode transition indicator for the STA3 is received from the AP, the STA3 may operate in the listening mode based on the listening mode transition indicator. When a listening mode transition indicator for the STA4 is received from the AP, the STA4 may maintain the receiving mode based on the listening mode transition indicator. The STA4 may receive the AP's next data frame without receiving the AP's initial control frame. When the listening mode transition indicator for the STA4 is received from the AP, the STA4 may operate in the listening mode based on the listening mode transition indicator.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of operating a station (STA) in a wireless local area network (LAN), the method comprising:
identifying, by a processor of the station, a restricted target wake time (rTWT) service period (SP) configured by an access point (AP); and
receiving, by the processor, a data frame from the AP within the rTWT SP without receiving an initial control frame of the AP.

2. The method of claim 1, wherein the STA is configured to operate in a receiving mode or a listening mode, the STA operating in the receiving mode receives the data frame without receiving the initial control frame, and the STA operating in the listening mode receives the data frame after receiving the initial control frame.

3. The method of claim 2, further comprising:
transitioning an operating mode of the STA from the listening mode to the receiving mode at a start time of the rTWT SP.

4. The method of claim 2, further comprising:
transitioning an operating mode of the STA from the receiving mode to the listening mode after an end time of the rTWT SP.

5. The method of claim 2, further comprising:
in response to the data frame including a listening mode transition indicator, transitioning an operating mode of the STA from the receiving mode to the listening mode after transmission of a response frame for the data frame.

6. The method of claim 1, further comprising:
receiving a beacon frame including rTWT SP information from the AP, wherein the rTWT SP information includes at least one of information on a start time of the rTWT SP or information on a duration of the rTWT SP, and the rTWT SP is identified based on the rTWT SP information.

7. The method of claim 1, wherein the initial control frame is a multi-user (MU)-request-to-send (RTS) frame or a buffer status report poll (BSRP) trigger frame.

8. The method of claim 1, wherein the STA is affiliated with a STA multi-link device (MLD), the AP is affiliated with an AP MLD, and the STA supports enhanced multi-link single radio (eMLSR) operations.

9. The method of claim 2, wherein the STA receives the data frame using multiple spatial streams.

10. A method of operating an access point (AP) in a wireless local area network (LAN), the method comprising:
transmitting, by a processor of the access point, restricted target wake time (rTWT) service period (SP) information; and
transmitting, by the processor, a data frame to a station (STA) without transmitting an initial control frame within a rTWT SP configured by the rTWT SP information.

11. The method of claim 10, wherein the STA is configured to operate in a receiving mode or a listening mode, the STA operating in the receiving mode receives the data frame without receiving the initial control frame, and the STA operating in the listening mode receives the data frame after receiving the initial control frame.

12. The method of claim 11, wherein an operating mode of the STA transitions from the listening mode to the receiving mode at a start time of the rTWT SP, and the operating mode of the STA transitions from the receiving mode to the listening mode after an end time of the rTWT SP.

13. The method of claim 11, wherein when the data frame includes a listening mode transition indicator, an operating mode of the STA transitions from the receiving mode to the listening mode after transmission of a response frame for the data frame.

14. The method of claim 10, wherein the rTWT SP information includes at least one of information on a start time of the rTWT SP or information on a duration of the rTWT SP, the initial control frame is a multi-user (MU)-request-to-send (RTS) frame or a buffer status report poll (BSRP) trigger frame, and the data frame is transmitted using multiple spatial streams.

15. The method of claim 10, wherein the STA is affiliated with a STA multi-link device (MLD), the AP is affiliated with an AP MLD, and the STA supports enhanced multi-link single radio (eMLSR) operations.

16. A station (STA) in a wireless local area network (LAN), comprising a processor, the station comprising:
identifying, by the processor, a restricted target wake time (rTWT) service period (SP) configured by an access point (AP); and
receiving, by the processor, a data frame from the AP within the rTWT SP without receiving an initial control frame of the AP.

17. The STA of claim 16, wherein the STA operates in a receiving mode or a listening mode, the STA operating in the receiving mode receives the data frame without receiving the initial control frame, and the STA operating in the listening mode receives the data frame after receiving the initial control frame.

18. The STA of claim 17, wherein the processor further causes the STA to perform:
transitioning an operating mode of the STA from the listening mode to the receiving mode at a start time of the rTWT SP; and
transitioning the operating mode of the STA from the receiving mode to the listening mode after an end time of the rTWT SP.

19. The STA of claim 17, wherein the processor further causes the STA to perform:
in response to the data frame including a listening mode transition indicator, transitioning an operating mode of the STA from the receiving mode to the listening mode after transmission of a response frame for the data frame.

20. The STA of claim 16, wherein the STA is affiliated with a STA multi-link device (MLD), the AP is affiliated with an AP MLD, the STA is an enhanced multi-link single radio (eMLSR) STA supporting eMLSR operations, and the STA receives the data frame using multiple spatial streams.
